(19) United States
(12) Patent Application Publication
(10) Pub. No.: US 2008/0012730 A1
(43) Pub. Date: Jan. 17, 2008

(54) DEVICE FOR GENERATING THE STANDBY FUNCTION IN A HEAD-UP DISPLAY

(75) Inventor: Michel SOLER, Carbon-Blanc (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 11/776,361

(22) Filed: Jul. 11, 2007

(30) Foreign Application Priority Data
Jul. 11, 2006 (FR) 0606307

(51) Int. Cl. G01C 23/00

(52) U.S. Cl. 340/973; 340/980

(57) ABSTRACT

The field of the invention is that of the generation of the standby function in aircraft cockpits. The term “standby” is the widely used English term for such a function. The invention relates to a device for generating the standby function for an aircraft. The device has inertia and pressure measuring sensors; electronic processing means are provided to process the data from the sensors; calculation means generate a graphical symbology representative of altitude, airspeed and attitude of the aircraft. Display means display the symbology belonging to a Head-up Display and making it possible to generate a collimated image overlaid on the external scene.

### RELATED APPLICATIONS

The present application is based on, and claims priority from, France Application Number 06 06307, filed Jul. 11, 2006, the disclosure of which is hereby incorporated by reference herein in its entirety.

### BACKGROUND OF THE INVENTION

1. Field of the Invention

The field of the invention is that of the generation of the standby function in aircraft cockpits. The term “standby” is the widely used English term for such a function.

2. Description of the Prior Art

In general, the displays displayed in an aircraft cockpit are of two types. A distinction is drawn between:

Instrument panel displays also known as Head-Down Displays or HDDs, and

Head-up Displays also known as HUDs.

FIG. 1, which partially depicts an aircraft instrument panel seen by the pilot, uses solid bold line to represent these various HDD and HUD displays.

Instrument panel displays or HDDs consist essentially of large screens, generally liquid crystal display screens, providing the air crew with the various items of information necessary for flying, navigating and controlling the craft. The display which displays the information needed for flying is also known as the PFD, which stands for primary flight display. These displays are connected, by means of databuses, to on-board electronic computers which use information from various sensors to generate the data needed for the display.

Of course, displays of information are of vital importance to flight safety. In the event of a serious breakdown of the instrument panel displays all aircraft are fitted with standby instruments that are able to display at least the information that is of vital importance in flying the aircraft, which is the information usually displayed on the PFD. This information is essentially:
the altitude of the aircraft;
the airspeed of the aircraft;
the attitude of the aircraft.

Up to the middle of the 1980s, these functions were provided by three different instruments known as the standby altimeter, the standby anemometer and the standby horizon. These three instruments had their own array of sensors so that they were completely self-contained in the event of any serious breakdown of the main displays or instruments. Since the end of the 1980s, these three standby instruments have been gradually supplanted by a single standby instrument known as an ESI, which stands for electronic standby instrument, or IESI, which stands for integrated electronic standby instrument. This ESI instrument, which is depicted in FIG. 1, combines into a single piece of equipment:
sensors for measuring the static and total pressure which are measurements needed to determine the altitude and the airspeed, the inertial sensors and the accelerometers needed to determine the altitude;
the processing electronics for calculating the airspeed, altitude and attitude information;
the electronics for calculating a graphical image representative of this information;
a flat liquid crystal display screen;
connection devices:
   pneumatic ones for connecting to the static and total pressure probes;
   electrical ones;
electronic input/output interfaces for accessing databuses;
control interfaces in the form of push buttons or rotary knobs.

As an option, the ESI standby instrument may have its own electrical power supply so that it can operate even if the standby power system fails.

FIG. 2 depicts a typical representation displayed on a standby instrument of this type in which the scale on the left provides airspeed information, the scale on the right provides altitude information and the figure in the middle provides information concerning the attitude of the aircraft.

This instrument which constitutes a significant advance over the conventional electromechanical instruments of earlier generations does, however, have certain disadvantages. Firstly, it is generally small in size so that it occupies very little space on the instrument panel. The standard format for screens of this type of so-called 3-ATI instrument, which stands for air transport indicator, is a square measuring approximately 60 millimeters along the side. This instrument is therefore viewed by the pilot at an average elevation and relative bearing angle of 2.5 degrees. As a result, the legibility of the information displayed is therefore poor. Secondly, even though the cost of such an instrument is lower than the cost of three conventional instruments, it is nonetheless fairly high.

In order to alleviate the aforementioned disadvantages, patent application US 2003/0030911 proposes incorporating the function of displaying the ESI information into the oxygen mask. This solution has numerous disadvantages. It can be implemented only when the pilot is wearing his oxygen mask, that is to say under conditions in which flight safety has been severely compromised. It is, of course, impossible to overlay the displayed information on the external scene. Finally, it is a solution that is complicated to implement and of necessity expensive in as much as the system used needs to be of small size, perfectly secure and operational under extreme conditions.

Displays known as Head-up Displays and also known by the abbreviation HUDs where first used on military aircraft and were then during the 1980s extended to more widespread use on all types of craft. These systems are integrated and fixed in the cockpit very accurately so as to be able to display symbols known as conformal symbols, that is to say symbols that are perfectly overlaid on the external scene. They present the pilot with visual information collimated in his field of view and overlaid on the external scene. This visual information relates more specifically to flying and is used in particular for take off and landing. Thus, the pilot may be presented with an artificial runway overlaid on the scene as indicated in FIG. 1. A HUD therefore comprises three main parts:
an electronic computer connected to the aircraft databuses;
a display device which may be a cathode ray tube or a liquid crystal display screen;
an optical system for collimating and overlaying images on the external scene. The overlaying on the scene is generally performed by an optical segment known as a “combiner”, as can be seen in FIG. 1. The position of the entire optical system is perfectly determined with respect to the cockpit so that what are called “conformal” symbols such as the horizon line or an artificial runway displayed by the display are overlaid very accurately on the external scene.

The main advantage of Head-up Displays is that they display a wide field of view which may measure as much as 35 degrees in relative bearing and 26 degrees in elevation.

### SUMMARY OF THE INVENTION

The object of the invention is to use the Head-up Display present in the cockpit as a full or partial replacement for the standby functions of the electronic standby instrument. In this way, many of the above disadvantages are resolved, without adding significantly to the cost.

More specifically, a subject of the invention is a device for generating the standby function for an aircraft, said device comprising at least:
inertia and pressure measuring sensors;
electronic processing means for processing the data from said sensors;
calculation means generating a graphical symbology representative of the altitude, the airspeed and the attitude of the aircraft;
display means for displaying said symbology;

wherein at least the display means belong to a Head-up Display (HUD) and make it possible to generate a collimated image overlaid on the external scene, the Head-up Display being an instrument that is integrated and fixed in the cockpit.

Advantageously, the inertia and pressure measuring sensors, the electronic processing means for processing the data from said sensors and the calculation means allowing the graphical symbology representative of the altitude, the airspeed and the attitude of the aircraft to be generated are incorporated into said Head-Up Display (HUD).

Advantageously, at least the inertia and pressure measuring sensors and the electronic processing means for processing the data from said sensors are incorporated into a standby instrument of the ESI type, the data needed for displaying the graphical symbology representative of the altitude, the airspeed and the attitude of the aircraft being transmitted from said standby instrument to the display means of the Head-up Display via at least one data and/or video bus.

### BRIEF DESCRIPTION OF THE DRAWINGS

The invention will be better understood and further advantages will become apparent from reading the description which will follow, which is given without any implied limitation and with reference to the attached figures among which:

FIG. 1 depicts a partial view of an aircraft instrument panel;

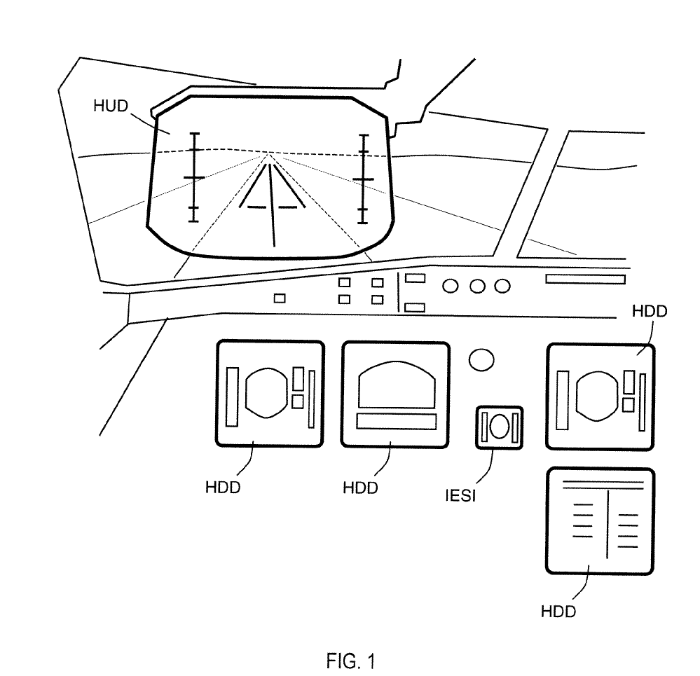

FIG. 2 depicts an example of symbology displayed on an electronic standby instrument;

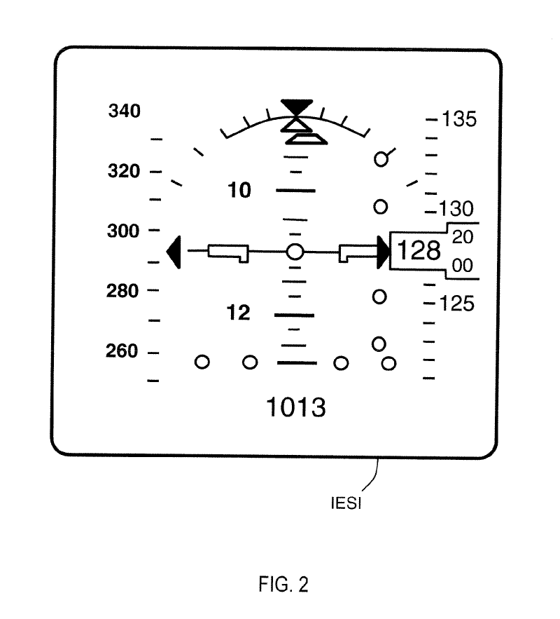

FIG. 3 depicts a first embodiment of a device for generating the standby function according to the invention;

FIG. 4 depicts a second embodiment of a device for generating the standby function according to the invention.

### MORE DETAILED DESCRIPTION

It is at the heart of the invention to display symbology of the PFD type devoted to the standby instrumentation using the Head-up Display. In this case, the symbology displayed requires a few minor alterations:
Since the symbology displayed is intended to be overlaid on the external scene, it is preferable for it to be made up mainly of numerals, text, curved lines and segments.
In general, Head-up Displays are monochrome green whereas standby instruments display a color image. Here too it is necessary to alter the symbology accordingly by using, for example, shades of gray, highlighting or other reverse video-type effects and flashing.
The display format of backup instruments is square, whereas that of Head-up Displays is rectangular. In this case, it is preferable to preserve the square format and to display the symbology in just part of the field of the Head-up Display, for example in a field measuring 25 degrees in relative bearing and 25 degrees in elevation.

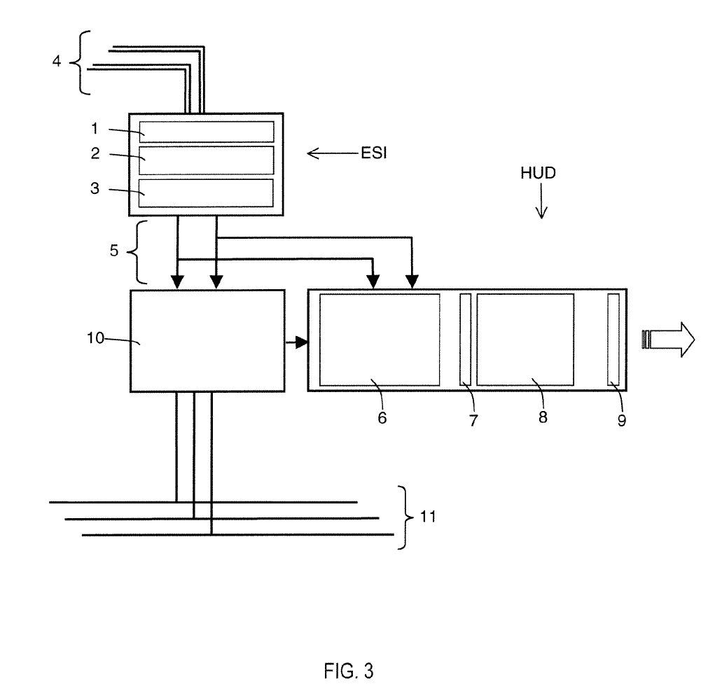

There are various possible ways of producing the device according to the invention. In a first embodiment depicted in FIG. 3, the electronic standby instrument ESI is kept in the cockpit. In this case, the standby instrument ESI conventionally comprises:
pressure and inertia measuring sensors 1 connected by pneumatic connections 4 to the static pressure and total pressure probes which have not been depicted in FIG. 3;
electronic processing means 2 for processing the data from said sensors 1;
symbol-generating electronics and electronic input/output interfaces 3 allowing access to data and/or video buses.

The Head-up Display HUD conventionally comprises:
symbol-generating electronics 6;
a display device 7 which may be a cathode ray tube or a liquid crystal matrix;
collimation optics 8, also known as relay optics;
a combiner 9 which overlays the image from the display device on the external scene. This image is symbolically represented by a striped straight arrow in FIG. 3.

This display is connected to an electronic computer 10 itself connected to the aircraft databus network 11.

In this device, the information needed for displaying the symbology is transmitted by buses 5 that transmit either data or video images. This information arrives either at the electronic computer or at the Head-up Display symbol-generating electronics.

When the information supplied by the standby instrument is of the video type, it consists of simple copies of the symbology displayed on the standby instrument. The computer or the symbol-generating electronics can easily receive this type of format because the latest digital technology means that the display is a simple digital-input monitor.

When the information supplied is data emitted in a standard aeronautical format such as the ARINC 429 format, it can also be easily processed by the computer or by the symbol-generating electronics in as much as these standards correspond to those operated by the vast majority of on-board computers, sensors and electronic instruments.

As has already been stated, the symbology displayed in the display is specially altered to suit the particularities of the Head-up Display in terms of its color, its size and its graphics. It will generally be displayed in green, the line width of the various symbols being of the order of one milliradian but which may, in this particular case of the use of HUD, be wider.

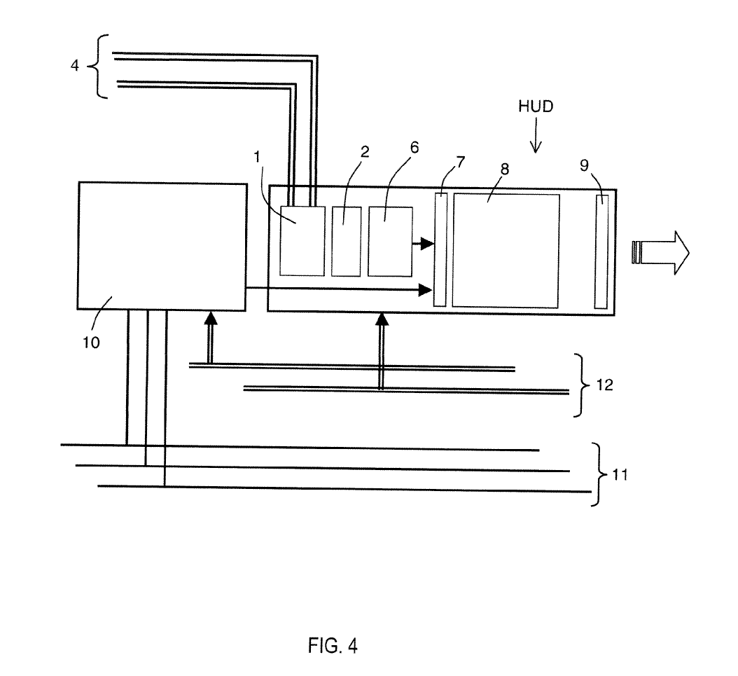

In a second embodiment, the standby instrument is omitted and the various functions performed by this instrument are incorporated into the Head-up Display. In this case, the display HUD comprises the basic functions of the standby instrumentation. As indicated in FIG. 4, the HUD then comprises:
inertia and pressure measuring sensors 1 connected by pneumatic links 4 to the static pressure and total pressure probes which have not been depicted in FIG. 4;
electronic processing means 2 for processing the data from said sensors;
symbol-generating electronics 6;
a display device 7 which may be a cathode ray tube or a liquid crystal matrix;
collimation optics 8, also known as relay optics;
a combiner 9 which overlays the image from the display device on the external scene.

This display is connected to an electronic computer 10 itself connected to the aircraft data bus network 11. The electrical power supply 12 at least to that part of the display that is devoted to performing the standby function needs to be provided by a backed-up standby power supply or by batteries dedicated to these functions.

Installing these new functions does not present any particular problems in as much as the total volume of the various sensors and of their associated processing electronics is no more than a few cubic centimeters, the volume available in a Head-up Display being far greater than that of an ESI.

Of course, the display retains its conventional functions of displaying flight assistance symbology.

Whatever the embodiment adopted, the standby symbology display mode may be triggered:
either automatically if a serious breakdown is detected;
or manually by the pilot on the basis of identified breakdown scenarios such as total or partial loss of Head Down Displays or partial loss of the HUD.

What is claimed is:

1. A device for generating the standby function for an aircraft, comprising:
inertia and pressure measuring sensors;
electronic processing means for processing data from said sensors;
calculation means for generating a graphical symbology representative of altitude, airspeed and attitude of the aircraft;
display means for displaying said symbology;
wherein at the display means belong to a Head-up Display and make it possible to generate a collimated image overlaid on the external scene, the Head-up Display being an instrument that is integrated and fixed in the cockpit.

2. The device for generating the standby function as claimed in claim 1, wherein the inertia and pressure measuring sensors, the electronic processing means for processing the data from said sensors and the calculation means allowing the graphical symbology representative of the altitude, the airspeed and the attitude of the aircraft to be generated are incorporated into said Head-up Display.

3. The device for generating the standby function as claimed in claim 1, wherein the inertia and pressure measuring sensors and the electronic processing means for processing the data from said sensors are incorporated into a standby instrument, the data needed for displaying the graphical symbology representative of the altitude, the airspeed and the attitude of the aircraft being transmitted from said standby instrument to the display means of the Head-up Display via at least one data and/or video bus.

4. The device for generating the standby function as claimed in claim 3, wherein said standby instrument is of the electronic instrumental standby (ESI) type.
